(19) United States
(12) Patent Application Publication
(10) Pub. No.: US 2026/0169563 A1
(43) Pub. Date: Jun. 18, 2026

(54) APPARATUS

(71) Applicant: SONY GROUP CORPORATION, Tokyo (JP)

(72) Inventors: Akihito NISHIIKE, Tokyo (JP); Hiroto KAWAGUCHI, Tokyo (JP); Emiri SAKIYAMA, Tokyo (JP)

(21) Appl. No.: 19/126,259

(22) PCT Filed: Sep. 21, 2023
(86) PCT No.: PCT/JP2023/034308

§ 371 Date: May 1, 2025

(30) Foreign Application Priority Data
Nov. 8, 2022 (JP) 2022-178723

(51) Int. Cl. G06F 3/01

(52) U.S. Cl. CPC G06F 3/016

(57) ABSTRACT

[Object] To present a wider variety of haptic sensations to a user. [Solving Means] Provided is an apparatus including: a first containing space and a second containing space that contain a fluid, which are partitioned using an elastically deformable wall portion; a generation unit that generates a plurality of signals on the basis of a haptic feedback or a control signal for information notification to a user who uses the apparatus; and a supply and discharge unit that, on the basis of the signal generated by the generation unit, supplies the fluid to the first containing space and the second containing space and discharges the fluid from the first containing space and the second containing space, in which the first containing space is stacked on the second containing space so that the first containing space is located between the second containing space and the user in a state in which the apparatus is used by the user.

### TECHNICAL FIELD

The present disclosure relates to an apparatus.

### BACKGROUND ART

In recent years, technologies of presenting various haptic sensations to users have been developed. For example, Patent Literature 1 has disclosed a technology of controlling inflow and outflow of a fluid into and out of a space to move a plurality of layers closer to or away from each other, thereby changing hardness of a surface touched by a user, so as to change a haptic sensation to be presented to the user.

### CITATION LIST

### Patent Literature

Patent Literature 1: WO 2021/090712

### DISCLOSURE OF INVENTION

### Technical Problem

Here, in order to further enhance the user experience, it is desirable to present a wider variety of haptic sensations to the user.

### Solution to Problem

According to the present disclosure, provided is an apparatus including: a first containing space and a second containing space that contain a fluid, which are partitioned using an elastically deformable wall portion; a generation unit that generates a plurality of signals on the basis of a haptic feedback or a control signal for information notification to a user who uses the apparatus; and a supply and discharge unit that, on the basis of the signal generated by the generation unit, supplies the fluid to the first containing space and the second containing space and discharges the fluid from the first containing space and the second containing space, in which the first containing space is stacked on the second containing space so that the first containing space is located between the second containing space and the user in a state in which the apparatus is used by the user.

### BRIEF DESCRIPTION OF DRAWINGS

FIG. 1 A schematic view showing an example of an overall configuration of a haptic presentation apparatus according to an embodiment of the present disclosure.

FIG. 2 A schematic view showing an example of a configuration of an upper layer 10.

FIG. 3 A schematic view showing an example of a configuration of a lower layer 20.

FIG. 4 An explanatory diagram showing an example of an internal configuration of a haptic presentation apparatus 1 according to the embodiment of the present disclosure.

FIG. 5 An explanatory view of a cross-sectional configuration obtained by taking the haptic presentation apparatus 1 along the line I-I shown in FIGS. 3 and 4.

FIG. 6 An explanatory view of a cross-sectional configuration obtained by taking the haptic presentation apparatus 1 along the line I-I shown in FIGS. 3 and 4.

FIG. 7 An explanatory diagram showing an example in which a generation unit 121 generates a plurality of driving signals by filtering a control signal on a time axis.

FIG. 8 An explanatory diagram showing an example in which the generation unit 121 generates a first signal and a second signal.

FIG. 9 An explanatory diagram showing an example in which the generation unit 121 generates a driving signal by separating a control signal depending on whether strength of the control signal is positive or negative.

FIG. 10 An explanatory diagram showing a graph showing a corresponding relationship between a value indicating a position included in a control signal and an amplitude value of a driving signal, which is stored in a storage unit 150.

FIG. 11 An explanatory diagram showing an example of a driving signal generated by the generation unit 121 on the basis of the corresponding relationship shown in FIG. 10 when a user U slides the position of a slider bar rightwards.

FIG. 12 An explanatory diagram showing an example in which the generation unit 121 generates a result obtained by dividing a pressure value indicated by the control signal by 2, as a driving signal.

FIG. 13 A flowchart showing an example of a flow of operation processing of the haptic presentation apparatus 1 according to the present embodiment.

FIG. 14 A configuration view of a haptic presentation apparatus 1 according to a first application example.

FIG. 15 A view showing an example of a controller on which a haptic presentation apparatus 1 according to a second application example is mounted.

FIG. 16 A configuration view of a haptic presentation apparatus 1 according to a third application example.

FIG. 17 A view showing an example in which the haptic presentation apparatus 1 shown in FIG. 16 is mounted inside a vehicle.

FIG. 18 Another example of an upper layer 10 of the haptic presentation apparatus 1 according to the third application example.

FIG. 19 Another example of the upper layer 10 of the haptic presentation apparatus 1 according to the third application example.

FIG. 20 A block diagram showing a hardware configuration example of the haptic presentation apparatus 1.

FIG. 21 Another example of the upper layer 10 of the haptic presentation apparatus 1.

FIG. 22 Another example of the upper layer 10 of the haptic presentation apparatus 1.

FIG. 23 Another example of the upper layer 10 of the haptic presentation apparatus 1.

### MODE(S) FOR CARRYING OUT THE INVENTION

Hereinafter, favorable embodiments of the present disclosure will be described in detail with reference to the accompanying drawings. It should be noted that in the present specification and the drawings, components with substantially the same functional configurations will be denoted by the same reference signs and duplicated descriptions will be omitted.

Moreover, in the present specification and the drawings, a plurality of components with substantially the same functional configurations will be sometimes distinguished by adding a different alphabet or a combination of a plurality of alphabets following the same reference sign. It should be noted that in a case where it is not particularly necessary to distinguish the plurality of components with substantially the same functional configurations from each other, each of the plurality of components will be denoted only by the same reference sign.

It should be noted that the descriptions will be given in the following order.
1. Overall Configuration of Haptic Presentation Apparatus According to Embodiment of Present Disclosure

2. Internal Configuration of Haptic Presentation Apparatus According to Embodiment of Present Disclosure
3. Generation Example of Driving Signal by Generation Unit 121
4. Operation Processing Example According to Present Embodiment
5. Application Examples
6. Hardware Configuration
7. Supplement

### 1. Overall Configuration of Haptic Presentation Apparatus According to Embodiment of Present Disclosure

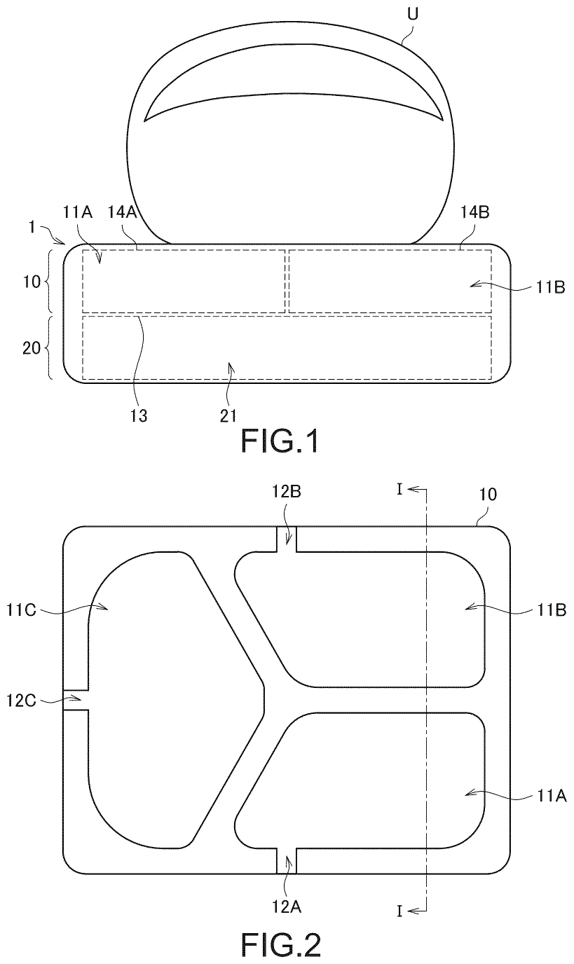

FIG. 1 is a schematic view showing an example of an overall configuration of a haptic presentation apparatus according to an embodiment of the present disclosure. The haptic presentation apparatus 1 is an example of an apparatus in the present disclosure. As shown in FIG. 1, the haptic presentation apparatus 1 includes an upper layer containing space 11A, an upper layer containing space 11B, and a lower layer containing space 21 inside it. The upper layer containing space 11 is an example of a first containing space. The lower layer containing space 21 is an example of a second containing space. In the present specification, in a case where it is not particularly necessary to distinguish the upper layer containing space 11 and the lower layer containing space 21 from each other, they will be simply referred to as containing spaces.

Presentation surfaces 14 (presentation surface 14A and presentation surface 14B) of wall portions partitioning the upper layer containing spaces 11, which are wall portions exposed to the outside, are elastically deformable. In a state in which the presentation surfaces 14 are used by the user U, the presentation surfaces 14 are held in contact with a body part of the user U, such as a finger or a palm. The presentation surfaces 14 are capable of presenting various haptic sensations to the user U by being elastically deformed.

The upper layer containing spaces 11 are stacked on the lower layer containing space 21 so that upper layer containing spaces 11 are located between the lower layer containing space 21 and the user U in a state in which they are used by the user U. In the example shown in FIG. 1, the upper layer containing spaces 11 are partitioned in an upper layer 10 (an example of a layer). Moreover, the lower layer containing space 21 is partitioned in a lower layer 20 (an example of the layer) stacked on the upper layer 10.

Wall portions of the wall portions partitioning the upper layer containing spaces 11, which are held in contact with the wall portions partitioning the lower layer containing space 21, are elastically deformable. Moreover, wall portions of the wall portions partitioning the lower layer containing space 21, which are held in contact with the wall portions partitioning the upper layer containing spaces 11, are elastically deformable. The elastically deformable material may be, for example, a rubber, silicon, a vinyl chloride resin, or the like.

The wall portions of the wall portions partitioning the upper layer containing spaces 11, which are held in contact with the wall portions partitioning the lower layer containing space 21 and the wall portions of the wall portions partitioning the lower layer containing space 21, which are held in contact with the wall portions partitioning the upper layer containing spaces 11, may be integrally configured. FIG. 1 shows an example in which a part of the wall portions partitioning the upper layer containing space 11A, a part of the wall portions partitioning the upper layer containing space 11B, and a part of the wall portions partitioning the lower layer containing space 21 are integrally configured as a layer isolation portion 13.

Next, referring to FIG. 2, a configuration of the upper layer 10 shown in FIG. 1 will be described in detail. FIG. 2 is a schematic view showing an example of the configuration of the upper layer 10. FIG. 2 shows a view of the upper layer 10 as viewed from the side of the presentation surfaces 14 in contact with the user U. As shown in FIG. 2, the upper layer 10 includes upper layer containing spaces 11A to 11C and outflow and inflow ports 12A to 12C.

The upper layer containing spaces 11 are spaces capable of containing a fluid. The type of fluid contained in the upper layer containing spaces 11 is not particularly limited. For example, the type of fluid contained in the upper layer containing spaces 11 may be a gas, such as air or helium, or may be a liquid, such as water or oil. Outflow and inflow ports 12 are provided in the upper layer containing spaces 11. A fluid is supplied into the upper layer containing spaces 11 through the outflow and inflow ports 12. Alternatively, a fluid from the upper layer containing spaces 11 is discharged through the outflow and inflow ports 12.

The upper layer containing spaces 11 are partitioned by the wall portions. It is desirable to use a material, such as plastic or metal, which is elastically deformed by the pressure of the fluid contained in the upper layer containing spaces 11, for the wall portions isolating the upper layer containing spaces 11 adjacent to each other. Moreover, after the upper layer containing spaces 11 are partitioned by the wall portions formed of a material that is elastically deformed, the upper layer containing spaces 11 may be further isolated by a material that is not elastically deformed. With this configuration, the upper layer containing space 11 is hardly affected by a pressure depending on a volume change of a fluid contained in the other upper layer containing spaces 11. Therefore, the user can more easily recognize that a haptic sensation presented by the inflow and outflow of the fluid contained in the upper layer containing space 11 is a haptic sensation different from a haptic sensation presented by the inflow and outflow of the fluid contained in the other upper layer containing spaces 11.

Moreover, the wall portions exposed to the outside out of the wall portions partitioning the upper layer containing spaces 11, excluding the presentation surfaces 14 (not shown), may be formed of a material that is not elastically deformed by the pressure of the fluid contained in the upper layer containing spaces 11. Moreover, after the upper layer containing spaces 11 are partitioned by the wall portions formed of a material that is elastically deformed, the wall portions exposed to the outside other than the presentation surfaces 14 may be further covered with a material not elastically deformed. Accordingly, only the presentation surfaces 14 of the wall portions exposed to the outside, which is touched by the user, is elastically deformed by the inflow and outflow of the fluid. Thus, the presentation surfaces 14 are more efficiently elastically deformed.

The volumes of the upper layer containing spaces 11A to 11C partitioned in the upper layer 10 may be the same volume or may be different volumes. Moreover, the shapes of the upper layer containing spaces 11A to 11C partitioned in the upper layer 10 may be the same shape or may be different shapes. Moreover, although FIG. 2 shows an example in which the three upper layer containing spaces 11 are partitioned in the upper layer 10, the number of upper layer containing spaces 11 is not particularly limited as long as one or more upper layer containing spaces 11 are partitioned in the upper layer 10.

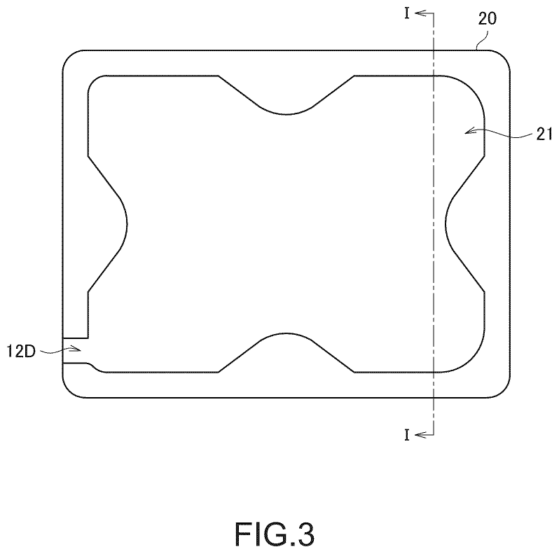

Next, referring to FIG. 3, a configuration of the lower layer 20 will be described in detail. FIG. 3 is a schematic view showing an example of a configuration of the lower layer 20. FIG. 3 shows a schematic view of the lower layer 20 as viewed from the side of the upper layer 10. As shown in FIG. 3, the lower layer 20 includes the lower layer containing space 21 and an outflow and inflow port 12D.

The lower layer containing space 21 is a space capable of containing a fluid. The lower layer containing space 21 contains the same fluid or a different fluid as/from the fluid contained in the upper layer containing spaces 11. The outflow and inflow port 12D is provided in the lower layer containing space 21. A fluid contained in the lower layer containing space 21 is supplied through the outflow and inflow port 12D. Alternatively, a fluid from the lower layer containing space 21 is discharged through the outflow and inflow port 12D.

It should be noted that although FIG. 3 shows an example in which the lower layer 20 includes the single lower layer containing space 21 and the lower layer containing space 21 is stacked over the plurality of upper layer containing spaces 11, the number of the lower layer containing spaces 21 partitioned in the lower layer 20 is not particularly limited as long as they are one or more lower layer containing spaces 21. Moreover, the lower layer containing space 21 may be stacked over the plurality of upper layer containing spaces 11 or may be stacked on only one upper layer containing space 11. It should be noted that in a case where two or more lower layer containing spaces 21 are partitioned in the lower layer 20, the lower layer containing spaces 21 are partitioned with a configuration similar to that in the case where the plurality of upper layer containing spaces 11 is partitioned in the upper layer 10.

### 2. Internal Configuration of Haptic Presentation Apparatus According to Embodiment of Present Disclosure

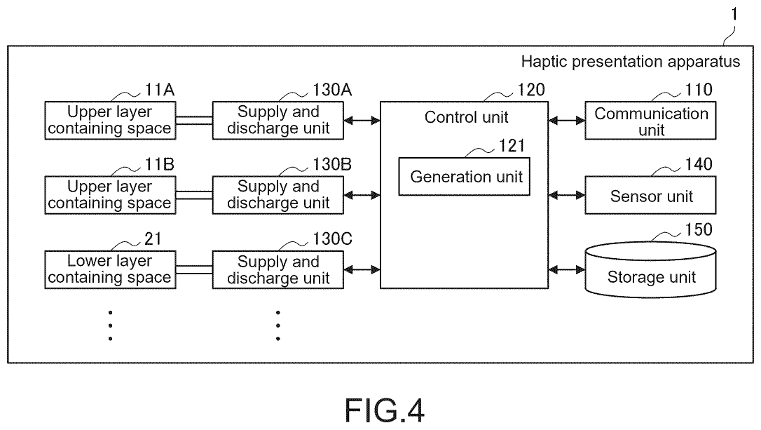

Next, referring to FIG. 4, an internal configuration of the haptic presentation apparatus 1 according to the embodiment of the present disclosure will be described. FIG. 4 is an explanatory diagram showing an example of an internal configuration of the haptic presentation apparatus 1 according to the embodiment of the present disclosure. As shown in FIG. 4, the haptic presentation apparatus 1 includes the upper layer containing space 11A, the upper layer containing space 11B, the lower layer containing space 21, a communication unit 110, a control unit 120, supply and discharge units 130A to 130C, a sensor unit 140, and a storage unit 150. It should be noted that the internal configuration shown in FIG. 4 is an example, and the configuration of the haptic presentation apparatus 1 is not limited thereto.

### Communication Unit 110

The communication unit 110 connects to an external device with a wire or wirelessly for communicating and exchanging data with it. For example, the communication unit 110 receives from the external device a haptic feedback or a control signal for information notification to a user who uses the haptic presentation apparatus 1 by wireless communication, such as Wi-Fi (registered trademark) or Bluetooth (registered trademark).

### Control Unit 120

The control unit 120 functions as an arithmetic processing device and a control device and controls general operations in the haptic presentation apparatus 1 in accordance with various programs. The control unit 120 is realized by an electronic circuit, e. g., a central processing unit (CPU) or a microprocessor. Moreover, the control unit 120 may include a read only memory (ROM) for storing programs, arithmetic operation parameters, and the like to be used, and a random access memory (RAM) for temporarily storing parameters and the like, which are changed as appropriate.

### Generation Unit 121

The control unit 120 according to the present embodiment also functions as the generation unit 121. The generation unit 121 generates a plurality of signals on the basis of a control signal received by the communication unit 110. A signal for controlling driving of supply and discharge units 130, which is generated by the generation unit 121, will be referred to as a driving signal. A generation method for the driving signal by the generation unit 121 will be described later in detail.

### Supply and Discharge Unit 130

The supply and discharge units 130 supply the fluid to the containing space and discharge the fluid from the containing space through the outflow and inflow ports 12. It should be noted that in the present specification, the supply of the fluid to the containing space and the discharge of the fluid from the containing space will be also referred to as inflow and outflow of the fluid into and out of the containing spaces. A plurality of supply and discharge units 130 is provided corresponding to the respective containing spaces. For example, FIG. 4 shows an example in which the supply and discharge unit 130A is provided corresponding to the upper layer containing space 11A, the supply and discharge unit 130B is provided corresponding to the upper layer containing space 11B, and the supply and discharge unit 130C is provided corresponding to the lower layer containing space 21.

The supply and discharge units 130 have flow channels. The flow channels connect to the outflow and inflow ports 12, which are a supply port for a fluid to the containing space and a discharge port for a fluid from the containing space.

The supply and discharge units 130 may include supply sources that store a fluid to be contained in the containing spaces. It should be noted that a supply source may be provided in each of the supply and discharge units 130 corresponding to the containing spaces or a single supply source may be shared by the plurality of supply and discharge units 130. Moreover, in a case where the fluid is air, the supply source may be omitted. In that case, the supply and discharge units 130 supply the outside air to the containing spaces and discharge the air to the outside from the containing spaces.

The supply and discharge units 130 supply the fluid to the containing spaces from the supply source via the flow channels and the outflow and inflow ports 12 by driving of a drive unit, e.g., a fan, blower, or pump. Moreover, the supply and discharge units 130 discharge to the supply source the fluid from the containing spaces through the outflow and inflow ports 12 and the flow channels by driving of the drive unit. Moreover, the supply and discharge units 130 may include a device capable of opening and closing, such as a valve. For example, the supply and discharge units 130 open and close the valve by driving of the drive unit and keep a fluid, such as air, in the containing space. Accordingly, the containing spaces are capable of keeping a fluid in the containing spaces also after driving of the drive unit is stopped. Therefore, as compared to a case where the drive unit is kept driving, the power consumption when the wall surfaces of the containing spaces are continued to be deformed can be reduced.

The supply and discharge units 130 supply and discharge the fluid on the basis of a driving signal generated by the generation unit 121. More specifically, the control unit 120 controls the drive unit of the supply and discharge units 130 to supply and discharge the fluid on the basis of the driving signal.

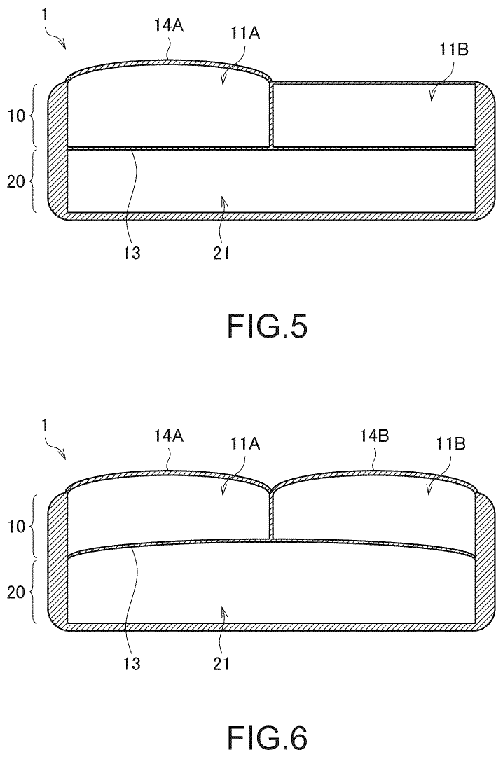

Here, changes of the presentation surfaces 14, which are caused by the inflow and outflow of the fluid into and out of the containing spaces by the supply and discharge units 130, will be described with reference to FIGS. 5 and 6. FIGS. 5 and 6 are explanatory views showing cross-sectional configurations, each of which is obtained by taking the haptic presentation apparatus 1 along the line I-I shown in FIGS. 3 and 4.

The presentation surfaces 14 are elastically deformed by the supply and discharge units 130 causing the fluid to flow into and out of the upper layer containing spaces 11, thereby presenting a haptic sensation to the user. For example, the presentation surface 14A changes into a state protruding to the user as shown in FIG. 5 from a flat state as shown in FIG. 1 by the supply and discharge units 130 supplying the fluid to the upper layer containing space 11A. Then, the presentation surface 14A changes into the flat state as shown in FIG. 1 from the state protruding to the user as shown in FIG. 5 by the supply and discharge units 130 discharging the fluid from the upper layer containing space 11A.

The user perceives a haptic sensation, such as a sensation of the presentation surface 14A vibrating or a sensation (pressure sensation) of sensing a pressure from the presentation surface 14A, by such a change of the state of the presentation surface 14A. In accordance with a change speed of the state of the presentation surface 14A, a degree of protruding, and the like, the user perceives a vibrating sensation or a pressure sensation. As an example, in a case where the inflow and outflow of the fluid into and out of the upper layer containing space 11A is performed at a frequency of 100 Hz, the presentation surface 14A presents a vibration to the user. As another example, in a case where the fluid is supplied so that the volume of the fluid contained in the upper layer containing space 11A linearly increases, the presentation surface 14A presents a pressure sensation to the user. Moreover, the supply and discharge units 130 may perform the inflow and outflow of the fluid so that the presentation surface 14A becomes a depressed state to the user from the state protruding to the user through the flat state.

Moreover, in a case where the supply and discharge units 130 cause the fluid to flow into and out of the lower layer containing spaces 21, the layer isolation portion 13 is deformed. Then, due to the deformation of the layer isolation portion 13, the presentation surfaces 14 of the upper layer containing spaces 11 stacked on the lower layer containing space 21 are deformed, thereby presenting a haptic sensation to the user.

For example, when the lower layer containing space 21 is supplied with the fluid, the presentation surface 14A and the presentation surface 14B of the upper layer containing space 11A and the upper layer containing space 11B change to a state protruding to the user as shown in FIG. 6 from the flat state as shown in FIG. 1.

The inflow and outflow of the fluid into and out of the lower layer containing space 21 are performed similar to the inflow and outflow of the fluid into and out of the upper layer containing spaces 11. Accordingly, the state of the presentation surfaces 14 changes, and the user perceives a haptic sensation, such as a sensation of the presentation surfaces 14 vibrating or a pressure sensation.

Here, the supply and discharge units 130 may perform the inflow and outflow of the fluid into and out of the upper layer containing spaces 11 and the inflow and outflow of the fluid into and out of the lower layer containing space 21 stacked on the upper layer containing spaces 11, at the same time or different times. In a case where the inflow and outflow of the fluid into and out of the upper layer containing spaces 11 and the inflow and outflow of the fluid into and out of the lower layer containing space 21 are simultaneously performed in accordance with different signals, the user can simultaneously recognize a plurality of different haptic sensations from the presentation surfaces 14.

For example, the inflow and outflow of the fluid into and out of the upper layer containing spaces 11 are performed in accordance with a signal with which the user can sense a vibration of the presentation surfaces 14 and the inflow and outflow of the fluid into and out of the lower layer containing space 21 are performed in accordance with a signal with which the user can sense a pressure from the presentation surfaces 14 in some cases. In this case, the presentation surfaces 14 are capable of simultaneously giving the user a vibrating sensation and a pressure sensation.

Moreover, the supply and discharge units 130 may perform the inflow and outflow of the fluid into and out of the plurality of upper layer containing spaces 11 at the same time or different times. For example, the supply and discharge units 130 sequentially perform the inflow and outflow of the fluid into and out of the upper layer containing spaces 11 adjacent to each other, such that the presentation surfaces 14 are capable of giving the user a moving sensation. Taking a more specific example, in a case where the finger of the user U is held in contact with the presentation surface 14A and the presentation surface 14B as in FIG. 1, when the supply and discharge units 130 perform the inflow and outflow of the fluid into and out of the lower layer containing space 21 after the inflow and outflow of the fluid into and out of the upper layer containing space 11A, the user U obtains a moving sensation rightwards.

The user perceives a more complicated haptic sensation by simultaneously performing the inflow and outflow of the fluid into and out of the plurality of upper layer containing spaces 11 and the inflow and outflow of the fluid into and out of the lower layer containing space 21 or perceives a simple haptic sensation by performing the inflow and outflow of the fluid to only one containing space. That is, with such a configuration, the user is capable of experiencing various haptic sensations.

As a comparative example to the haptic presentation apparatus 1 in the present embodiment, a device of capable of presenting a vibration, such as a vibration element, may be combined with a device that moves a resin with a motor or the like to present a pressure sensation, thereby presenting a vibration and a pressure sensation to the user.

However, the comparative example has a problem in that more types of mechanical parts should be provided as compared to the haptic presentation apparatus 1 in the present embodiment or a plurality of control methods for controlling a plurality of devices are required. On the other hand, the haptic presentation apparatus 1 in the present embodiment is capable of presenting a vibration and a pressure sensation by the same control method, and therefore the mechanical parts and the control circuit can be simplified. Moreover, a more detailed pressure sensation can be presented by presenting a pressure sensation by the inflow and outflow of the fluid, as compared to presentation of a pressure sensation by moving a resin with a motor or the like.

The change of the presentation surfaces 14, which is provided by the supply and discharge unit 130 supplying and discharging the fluid, has been described so far. The generation unit 121 generates a driving signal used when the supply and discharge unit 130 causes the fluid to flow in and out. Then, the control unit 120 determines a containing space into and out of which the fluid flows on the basis of the driving signal. For example, the control unit 120 may determine a containing space into and out of which the fluid flows on the basis of the signal on the basis of an amplitude value of the driving signal generated by the generation unit 121.

For example, it is assumed that a base area of the upper layer containing space 11 equals a base area of the lower layer containing space 21 stacked on the upper layer containing space 11 in a case where the thickness of the upper layer 10 and the lower layer 20 is defined as a height. Moreover, it is assumed that the presentation surface 14 and the layer isolation portion 13 are in the flat state and the volume of the lower layer containing space 21 is larger than the volume of the upper layer containing space 11. At this time, in a case where the amplitude value is equal to or lower than a threshold, the control unit 120 may determine the upper layer containing space 11 as a containing space into and out of which the fluid flows on the basis of the driving signal having this amplitude value. Moreover, in a case where the amplitude value is larger than the threshold, the control unit 120 may determine the lower layer containing space 21 as a containing space into and out of which the fluid flows on the basis of the driving signal having this amplitude value.

Moreover, the control unit 120 may determine a containing space into and out of which the fluid flows on the basis of the driving signal in accordance with a frequency of the driving signal. Moreover, the control unit 120 may determine a containing space into and out of which the fluid flows on the basis of the driving signal, depending on whether the driving signal is a signal that can provide the user a vibrating sensation or a signal that can provide the user a pressure sensation.

### Sensor Unit 140

The sensor unit 140 is a sensor that detects the state of the containing spaces. For example, the sensor unit 140 may be a pressure sensor that detects each containing space or a pressure related to the user's finger in contact with the presentation surfaces 14, which is provided in each containing space. Here, the pressure sensors may be provided in the flow channels or the outflow and inflow ports 12. Moreover, the sensor unit 140 may be distance sensors that measure a distance between the wall portions, which are provided in the wall portions partitioning each containing space. Moreover, the sensor unit 140 may be contact detection sensors that detect a contact between the wall portions, which are provided in the wall portions partitioning each containing space.

The control unit 120 may control the inflow and outflow of the fluid by the supply and discharge units 130 on the basis of a measurement result by the sensor unit 140. For example, in a case where the sensor unit 140 has detected a pressure equal to or larger than a threshold or a distance equal to or smaller than a threshold, the control unit 120 may stop the supply of the fluid to the containing space. Then, the control unit 120 may perform control to stop the supply of the fluid to the containing space, and then start the supply of the fluid to the containing space stacked on this containing space.

### Storage Unit 150

The storage unit 150 is realized by a ROM for storing programs, arithmetic operation parameters, and the like to be used for the processing of the control unit 120 and a RAM for temporarily storing parameters and the like, which are changed as appropriate.

### 3. Generation Example of Driving Signal by Generation Unit 121

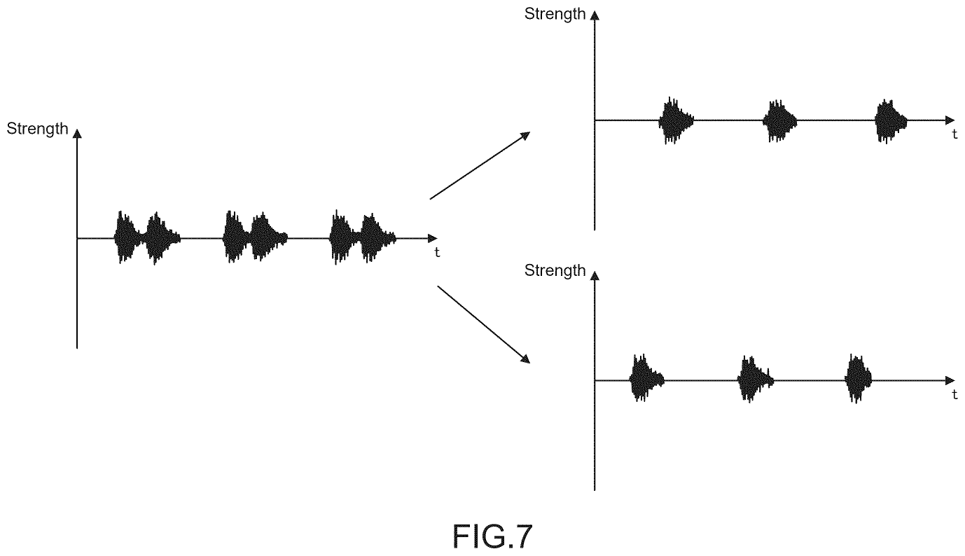

Next, an example of the generation method for the driving signal by the generation unit 121 will be described with reference to FIGS. 7 to 11.

The generation unit 121 generates a plurality of driving signals on the basis of a control signal received by the communication unit 110. The generation unit 121 may generate a plurality of driving signals by, for example, filtering a control signal on the time axis. FIG. 7 is an explanatory diagram showing an example in which the generation unit 121 generates a plurality of driving signals by filtering a control signal on the time axis.

A diagram shown in the left of FIG. 7 shows an example of a control signal received by the communication unit 110. The control signal is a signal indicating a time on the horizontal axis and indicating a strength on the vertical axis. It should be noted that the parameters of the control signal shown in FIG. 7 are exemplary, and other values, e.g., pressure values, may be used as the parameters instead of the strength.

The diagram shown in the upper right of FIG. 7 and the diagram shown in the lower right show two driving signals obtained by filtering a control signal on the time axis. In this manner, the generation unit 121 generates a plurality of signals by filtering a control signal to extract signals in different time ranges.

The control unit 120 determines, for each of the plurality of driving signals, a containing space into and out of which the fluid flows on the basis of the driving signal. For example, on the basis of combinations of time ranges for extracting the driving signals from the control signal and containing spaces, which have been prestored in the storage unit 150, the control unit 120 may determine a containing space into and out of which the fluid flows on the basis of the driving signal.

Although FIG. 7 shows an example in which two driving signals are generated, the number of signals to be generated is not particularly limited, and a plurality of driving signals may be generated, assuming that the number of containing spaces is its upper limit.

As another example of the generation method for the driving signal by the generation unit 121, the generation unit 121 may generate a driving signal (first signal) having a frequency component of a frequency equal to or higher than a predetermined frequency in the control signal and a driving signal (second signal) having a frequency component of a frequency lower than the first signal in the control signal.

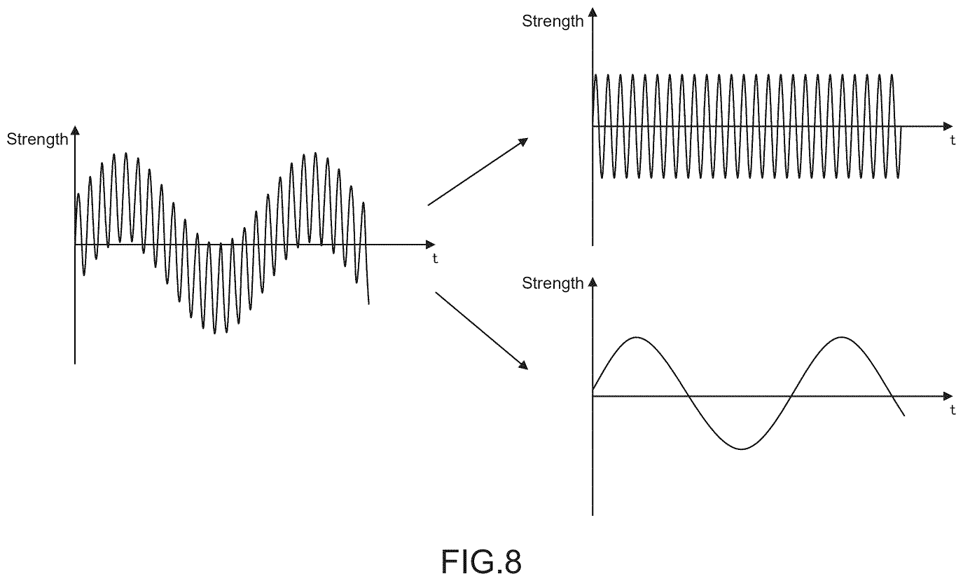

FIG. 8 is an explanatory diagram showing an example in which the generation unit 121 generates the first signal and the second signal. The generation unit 121 may generate the first signal by extracting a frequency component of a frequency equal to or higher than a predetermined frequency through a high-pass filter. Moreover, the generation unit 121 may generate the second signal by extracting a frequency component of a frequency lower than a frequency of the first signal used for generating the first signal, through a low-pass filter.

The left diagram of FIG. 8 is an example of the control signal received by the communication unit 110. The control signal is a signal indicating a time on the horizontal axis and indicating a strength on the vertical axis. The diagram shown in the upper right of FIG. 8 and the diagram shown in the lower right of FIG. 8 show two driving signals obtained by filtering the control signal through the high-pass filter and the low-pass filter.

The control unit 120 determines, for each of driving signals generated in this manner, a containing space into and out of which the fluid flows on the basis of the driving signal. At this time, the control unit 120 may determine a containing space so that the driving signal for the supply and discharge units 130 to cause the fluid to flow into and out of the upper layer containing spaces 11 and the driving signal for the supply and discharge units 130 to cause the fluid to flow into and out of the lower layer containing space 21 are signals of different frequencies.

For example, the control unit 120 determines a containing space corresponding to the first signal as the upper layer containing spaces 11 and determines a containing space corresponding to the second signal as the lower layer containing space 21 stacked on the upper layer containing spaces 11. Accordingly, the presentation surfaces 14 can present to the user a vibrating sensation by the inflow and outflow of the fluid into and out of the upper layer containing spaces 11 and a pressure sensation by the inflow and outflow of the fluid into and out of the lower layer containing space 21. It should be noted that depending on the frequency of the second signal, the presentation surfaces 14 can present to the user a vibration different in vibration rate from a vibration provided by the inflow and outflow of the fluid into and out of the upper layer containing spaces 11, by the inflow and outflow of the fluid into and out of the lower layer containing space 21. That is, the presentation surfaces 14 can simultaneously present to the user a plurality of vibrations different in rate.

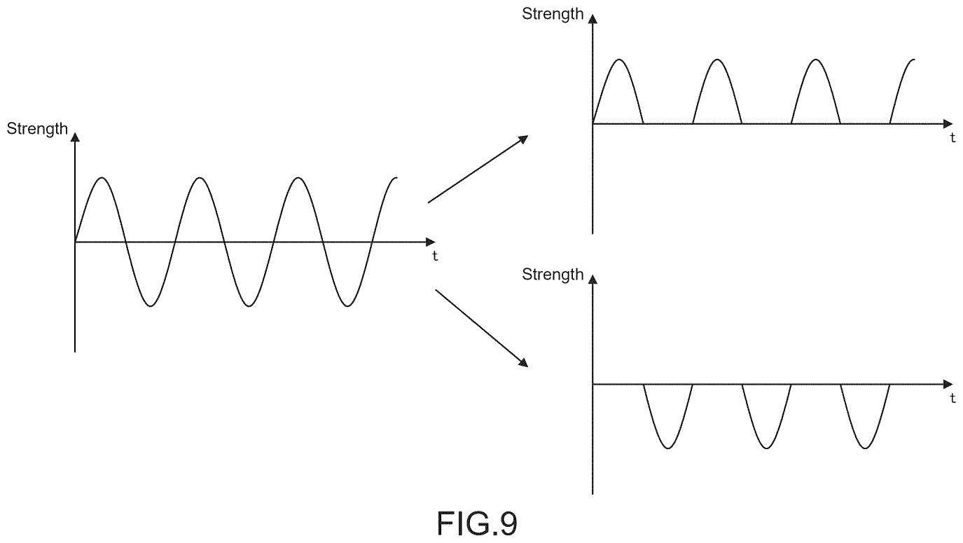

Moreover, as another example of the generation method for the driving signal by the generation unit 121, the generation unit 121 may generate a plurality of driving signals by separating the control signal depending on whether the strength of the control signal is positive or negative. FIG. 9 is an explanatory diagram showing an example in which the generation unit 121 generates the driving signal by separating the control signal depending on whether the strength of the control signal is positive or negative.

The diagram shown in the left of FIG. 9 shows an example of the control signal received by the communication unit 110. The control signal is a signal indicating a time on the horizontal axis and indicating a strength on the vertical axis. The diagram shown in the upper right of FIG. 9 shows an example of a driving signal generated by separating a signal with a positive strength from the control signal. The diagram shown in the lower right shown in FIG. 9 shows an example of a driving signal generated by separating a signal with a negative strength from the control signal.

It should be noted that although FIG. 9 shows an example in which the control signal is symmetric with respect to the positive or negative, the control signal separated by the generation unit 121 does not need to be symmetric.

Moreover, as another example of the generation method for the driving signal by the generation unit 121, the generation unit 121 may determine an amplitude value of each of the plurality of driving signals on the basis of the control signal. For example, the storage unit 150 may store a corresponding relationship between the value indicating the position included in the control signal and the amplitude value of the driving signal to be used for the inflow and outflow of the fluid by the supply and discharge units 130. The generation unit 121 determines an amplitude value corresponding to the value indicating the position as the amplitude value of the driving signal and generates a driving signal whose amplitude is this amplitude value and whose frequency is a predetermined frequency. Then, the control unit 120 may determine each of the plurality of upper layer containing spaces 11 adjacent to each other out of the plurality of upper layer containing spaces 11 as a containing space into and out of which the fluid flows on the basis of each of the plurality of driving signals.

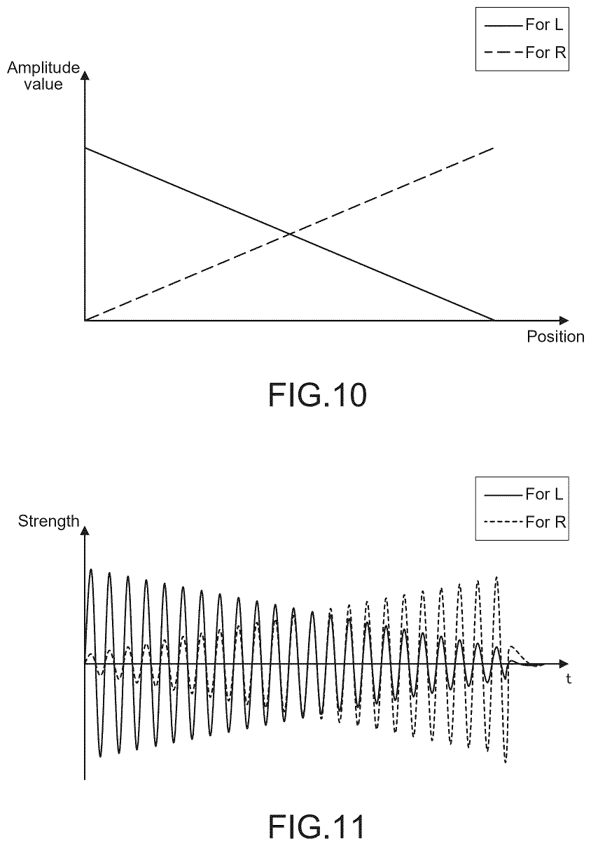

Here, a generation example of the driving signal by the generation unit 121 using the above-mentioned method in a case where the finger of the user U comes into contact with the presentation surface 14A and the presentation surface 14B as shown in FIG. 1 will be described with reference to FIGS. 10 and 11.

FIG. 10 is an explanatory diagram showing a graph showing a corresponding relationship between the value indicating the position included in the control signal and the amplitude value of the driving signal, which is stored in the storage unit 150. In FIG. 10, a corresponding relationship between the value indicating the position included in the control signal and an amplitude value of a driving signal (driving signal for L) to be used for the inflow and outflow of the fluid into and out of the upper layer containing space 11A having the presentation surface 14A, which is a presentation surface 14 on the left side as viewed from the user U, is shown as the solid line. Moreover, in FIG. 10, a corresponding relationship between the value indicating the position included in the control signal and an amplitude value of a driving signal (driving signal for R), which is presented by the inflow and outflow of the fluid into and out of the upper layer containing space 11B having the presentation surface 14B on the right side as viewed from the user U, is shown as the dotted line.

Here, the value indicating the position included in the control signal may be, for example, the value indicating the position of a slider bar, which can be operated by the user U, which is displayed on the external device. FIG. 11 is an explanatory diagram showing an example of a driving signal generated by the generation unit 121 on the basis of the corresponding relationship shown in FIG. 10 when the user U slides the position of the slider bar rightwards. FIG. 11 shows the driving signal for L, which is generated by the generation unit 121 on the basis of the corresponding relationship shown in FIG. 10, as the solid line. Moreover, FIG. 11 shows the driving signal for R, which is generated by the generation unit 121, on the basis of the corresponding relationship shown in FIG. 10, as the dotted line.

By the generation unit 121 generating the driving signal in this manner, the presentation surfaces 14 is capable of presenting a sensation of gradually moving rightwards when the user U slides the position of the slider bar rightwards.

Moreover, as another example of the generation method for the driving signal by the generation unit 121, the generation unit 121 may generate a plurality of driving signals on the basis of a pressure value indicated by the control signal. In a case where the driving signal is a pressure value, the supply and discharge units 130 continue to supply the fluid to the containing spaces until the pressure value detected by the sensor unit 140 becomes the pressure value indicated by the driving signal. The generation unit 121 may set, for example, a result obtained by subtracting a threshold from the pressure value indicated by the control signal, as the driving signal.

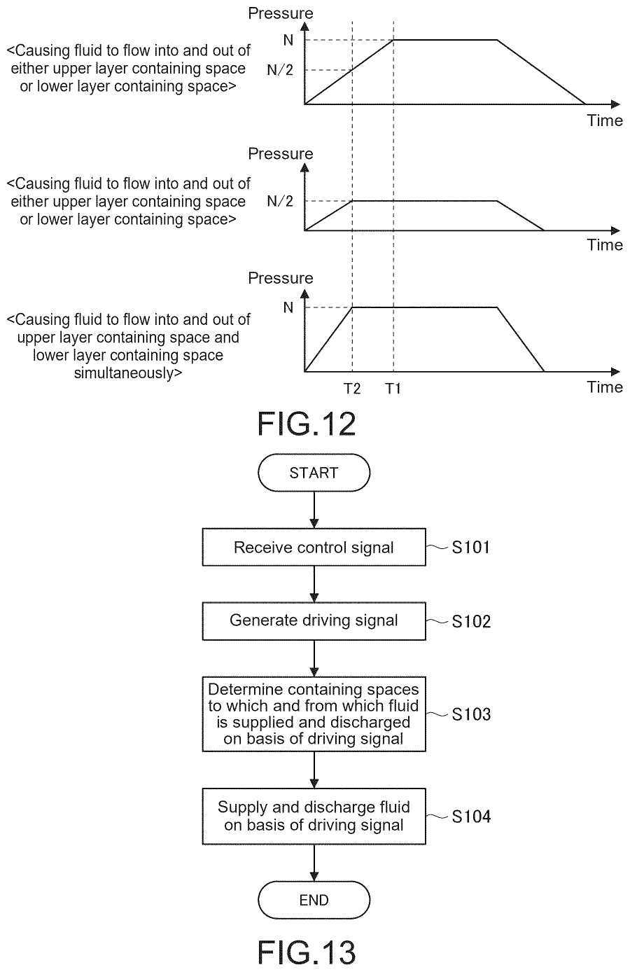

Moreover, the generation unit 121 may set a result obtained by dividing the pressure value indicated by the control signal by a constant, as the driving signal. FIG. 12 is an explanatory diagram showing an example in which the generation unit 121 generates a result, which is obtained by dividing the pressure value indicated by the control signal by 2, as the driving signal. FIG. 12 shows a change in the pressure value over time, which is exerted on the user's finger that comes into contact with the presentation surfaces 14.

The diagram shown in the top of FIG. 12 shows a change in the pressure value over time in a case where the fluid flows into and out of either the upper layer containing spaces 11 or the lower layer containing space 21 and the pressure value exerted on the user's finger that comes into contact with the presentation surfaces 14 reaches N. As shown in the top of FIG. 12, T1 is a time until the pressure value exerted on the user's finger that comes into contact with the presentation surfaces 14 reaches N in a case where the fluid is supplied so that the volume of the fluid contained in the upper layer containing spaces 11 or the lower layer containing space 21 linearly increases.

The diagram shown in the middle of FIG. 12 shows a change in the pressure value over time in a case where the fluid flows into and out of either the upper layer containing spaces 11 or the lower layer containing space 21 and the pressure value exerted on the user's finger that comes into contact with the presentation surfaces 14 reaches N/2. As shown in the middle of FIG. 12, T2 shorter than T1 is a time until the pressure value exerted on the user's finger that comes into contact with the presentation surfaces 14 reaches N/2.

Here, the generation unit 121 generates N/2, which is a result obtained by dividing N that is the pressure value indicated by the control signal by 2, as the driving signal. In a case where the inflow and outflow of the fluid into and out of the upper layer containing spaces 11 and the lower layer containing space 21 are controlled by this driving signal and the lower layer containing space 21 is stacked on the upper layer containing spaces 11, the pressure value exerted on the user's finger that comes into contact with the presentation surfaces 14 changes over time as shown in the bottom of FIG. 12. In such a case, T2 is a time until the pressure value exerted on the user's finger that comes into contact with the presentation surfaces 14 reaches N. In this manner, in a case where the fluid simultaneously flows into and out of the lower layer containing space 21 and the upper layer containing spaces 11, the time until the pressure value exerted on the user's finger that comes into contact with the presentation surfaces 14 reaches N is shortened, as compared to the case of causing the fluid to flow into and out of either the upper layer containing spaces 11 or the lower layer containing space 21. That is, in accordance with the above-mentioned method, the time responsiveness when the pressure value exerted on the user's finger that comes into contact with the presentation surfaces 14 is made to reach the pressure value indicated by the control signal increases.

Moreover, as another example of the generation method for the driving signal by the generation unit 121, the generation unit 121 may generate a plurality of driving signals that are the same in frequency and phase. These driving signals may have the same frequency and phase as the frequency and phase of a control signal. For example, on the basis of a threshold set in accordance with the volume of the containing space or the performance of the drive unit of the supply and discharge units 130, the generation unit 121 may determine amplitude values of the driving signals to be generated. Then, the control unit 120 determines the upper layer containing spaces 11 and the lower layer containing space 21 stacked on the upper layer containing spaces 11, as containing spaces into and out of which the fluid flows on the basis of each of the plurality of driving signals having the same frequency and phase.

The generation example of the plurality of driving signals by the generation unit 121 has been described so far. As described above, the generation unit 121 generates a plurality of driving signals on the basis of the control signal. With such a configuration, a plurality of driving signals can be generated on the basis of a single control signal received by the communication unit 110. Thus, the transmission band can be reduced as compared to a case where the communication unit 110 receives a plurality of driving signals.

### 4. Operation Processing Example According to Present Embodiment

Next, a flow of operation processing of the haptic presentation apparatus 1 according to the present embodiment will be described with reference to FIG. 13. FIG. 13 is a flowchart showing an example of a flow of operation processing of the haptic presentation apparatus 1 according to the present embodiment.

As shown in FIG. 13, first of all, the communication unit 110 receives a control signal (S101). The generation unit 121 generates a plurality of driving signals on the basis of the control signal received by the communication unit 110 (S102).

Subsequently, for each of the plurality of driving signals generated by the generation unit 121, the control unit 120 determines a containing space to which and from which the fluid is supplied and discharged on the basis of the driving signal (S103). Then, the supply and discharge unit 130 performs the inflow and outflow of the fluid into and out of the containing space on the basis of the driving signal (S104).

### 5. Application Examples

Next, application examples of the haptic presentation apparatus 1 according to the present disclosure will be described.

### First Application Example

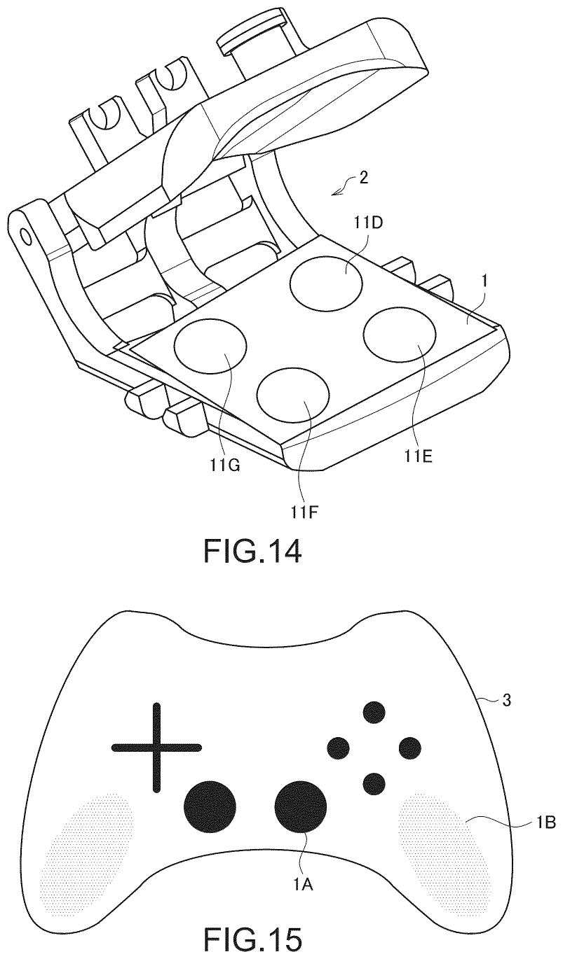

First of all, a first application example will be described with reference to FIG. 14. FIG. 14 is a configuration view of the haptic presentation apparatus 1 according to the first application example. The haptic presentation apparatus 1 is mounted on a clip-type attachment tool 2 attachable to the user's finger. By attaching the attachment tool 2 so that the haptic presentation apparatus 1 is held in contact with the ball of the finger, the user is capable of perceiving a haptic sensation presented by the haptic presentation apparatus 1 while moving the finger. It should be noted that the shape of the attachment tool 2 is not limited to the clip-type as long as the haptic presentation apparatus 1 can be fixed in contact with the user, and for example, the haptic presentation apparatus 1 may be mounted inside it in the form of a ring.

As shown in FIG. 14, the haptic presentation apparatus 1 includes upper layer containing spaces 11D to 11G. Moreover, the haptic presentation apparatus 1 includes a lower layer containing space 21 (not shown) that is stacked on the upper layer containing spaces 11D to 11G. It should be noted that the number of upper layer containing spaces 11 and lower layer containing spaces 21 is not limited to this example.

When the user interacts a virtual world by using the external device, the haptic presentation apparatus 1 according to the first application example may present a haptic sensation. For example, by causing the fluid contained in each of the upper layer containing spaces 11 to flow in and out, a vibration may be presented to the user. Then, by causing the fluid contained in the lower layer containing space 21 to flow in and out, a pressure sensation may be presented to the user via the upper layer containing spaces 11.

More specifically, when the communication unit 110 has received a control signal based on the user's touch on a virtual object in a virtual world, the supply and discharge units 130 may cause the fluid contained in the lower layer containing space 21 to flow in and out, thereby presenting a pressure sensation to the user. Moreover, while the user is holding this virtual object, the supply and discharge units 130 may cause the fluid contained in the upper layer containing spaces 11 to flow in and out, thereby presenting a vibration. Then, in a case of having received a control signal based on the user's action of leaving the virtual object that the user has held, the supply and discharge units 130 may cause the fluid contained in the lower layer containing space 21 to flow in and out, thereby immediately presenting a pressure sensation to the user. It should be noted that the supply and discharge units 130 may set the speed and the like of the inflow and outflow of the fluid into and out of the containing spaces to be different in accordance with a contact time or a holding time of the virtual object by the user, a distance between the virtual object and the user, or the like, thereby presenting different haptic sensations.

### Second Application Example

Next, a second application example will be described with reference to FIG. 15. FIG. 15 is a view showing an example of a controller on which the haptic presentation apparatus 1 according to the second application example is mounted. A controller 3 shown in FIG. 15 includes a haptic presentation apparatus 1A and a haptic presentation apparatus 1B. The user holds the controller 3 and operates buttons, joystick, and the like of the controller 3, thereby making operations of a game presented by a game console connected to the controller 3.

The haptic presentation apparatus 1A is mounted on the joystick of the controller 3. The haptic presentation apparatus 1B is mounted on a grip of the controller 3. The user touches the haptic presentation apparatus 1A and the haptic presentation apparatus 1B when making an operation of the game with the controller 3 or when watching the game presented by the game console while holding the controller 3.

The haptic presentation apparatus 1A and the haptic presentation apparatus 1B present haptic sensations depending on a situation in the game by causing the fluid contained in the containing spaces to flow in and out by the supply and discharge units 130 of the haptic presentation apparatus 1. For example, in a case of having received a control signal based on a character's action of walking in the game, the supply and discharge units 130 may cause the fluid contained in the containing spaces to flow in and out, thereby presenting a vibration as a rough terrain. Moreover, in that case, the supply and discharge units 130 may cause the fluid to flow in and out contained in a containing space different from these containing spaces, thereby further presenting a pressure sensation as a sensation of heartbeat. In this manner, the haptic presentation apparatus 1 according to the second application example can provide a sense of presence to the user.

### Third Application Example

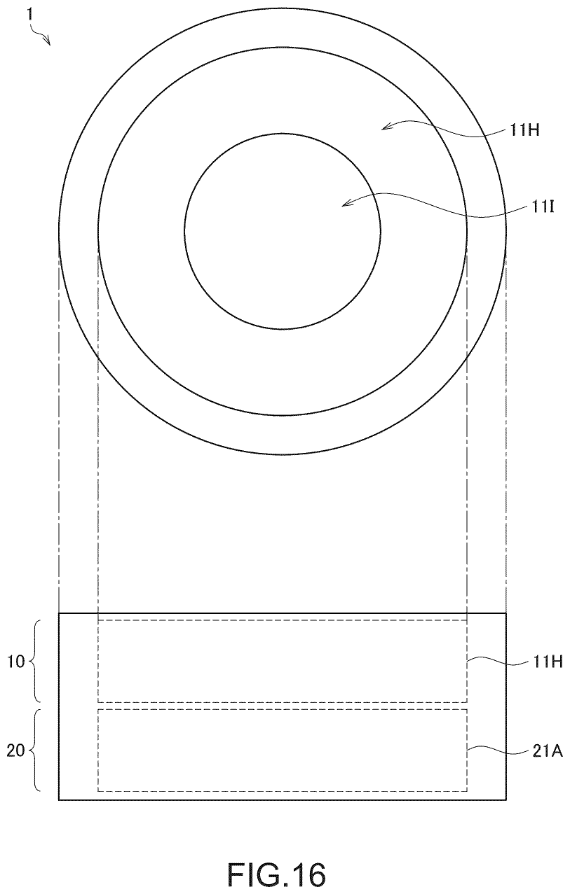

Next, a third application example will be described with reference to FIGS. 16 to 19. FIG. 16 is a configuration view of the haptic presentation apparatus 1 according to the third application example. In the top of FIG. 16, a view of the haptic presentation apparatus 1 as viewed from the side in contact with the user is shown. Moreover, in the bottom of FIG. 16, a view of the haptic presentation apparatus 1 as viewed from the side is shown, assuming that the side in contact with the user is an upper side.

As shown in FIG. 16, the haptic presentation apparatus 1 includes an upper layer containing space 11H, an upper layer containing space 11I, and a lower layer containing space 21A. The upper layer containing space 11H and the upper layer containing space 11I are present on concentric circles. Moreover, the upper layer containing space 11H and the upper layer containing space 11I are partitioned in the upper layer 10 and the lower layer containing space 21A is partitioned in the lower layer 20.

The sensor unit 140 according to this application example detects external pressures on the upper layer containing space 11H and the upper layer containing space 11I. When the sensor unit 140 detects a pressure value equal to or larger than a predetermined value, the communication unit 110 sends a signal to the external device. Accordingly, the user is capable of operating the external device by pushing the presentation surface 14 of the upper layer containing space 11H or the upper layer containing space 11I. In accordance with such a user operation, a haptic feedback or a control signal for information notification to the user may be generated. In this application example, the generation unit 121 may generate a control signal in accordance with a detection result by the sensor unit 140.

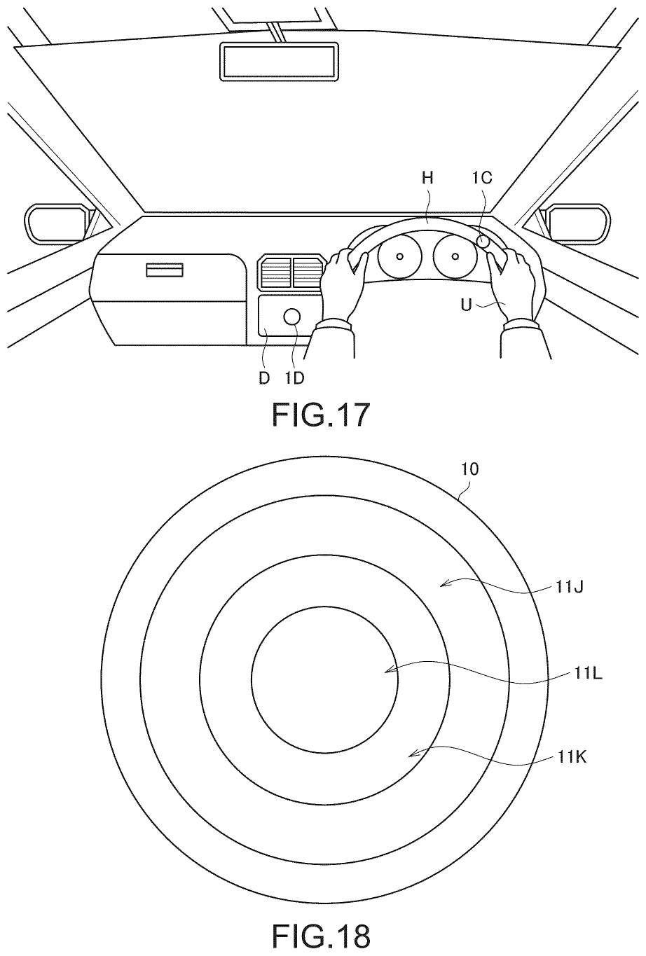

FIG. 17 is a view showing an example in which the haptic presentation apparatus 1 shown in FIG. 16 is mounted inside a vehicle. As shown in FIG. 17, a haptic presentation apparatus 1C is mounted on a handle H to be used for car driving. Moreover, a haptic presentation apparatus 1D is mounted on a car dashboard D.

The user U makes operations related to the car, such as car driving operations and operations of in-vehicle air-conditioner, by pushing the presentation surface 14 of the haptic presentation apparatus 1C or the haptic presentation apparatus 1D. The supply and discharge unit 130 performs the inflow and outflow of the fluid into and out of the containing space so as to present a haptic sensation as a feedback with respect to the operation by the user U. Here, the haptic presentation apparatus 1 may connect to a device capable of making a phone call, such as a smartphone. In this case, the supply and discharge units 130 may perform the inflow and outflow of the fluid into and out of the containing spaces so as to present a haptic sensation as an incoming call notification to the user U or the like. At this time, when the user U has pushed the presentation surface 14 and the sensor unit 140 has accordingly detected a pressure value equal to or larger than a predetermined value, the communication unit 110 may send a signal to the device, such that the device starts calling.

Moreover, the haptic presentation apparatus 1 may be connected to car navigation. In this case, the supply and discharge units 130 may perform the inflow and outflow of the fluid into and out of the containing spaces so as to present a haptic sensation as a notification for guiding a direction to the user U.

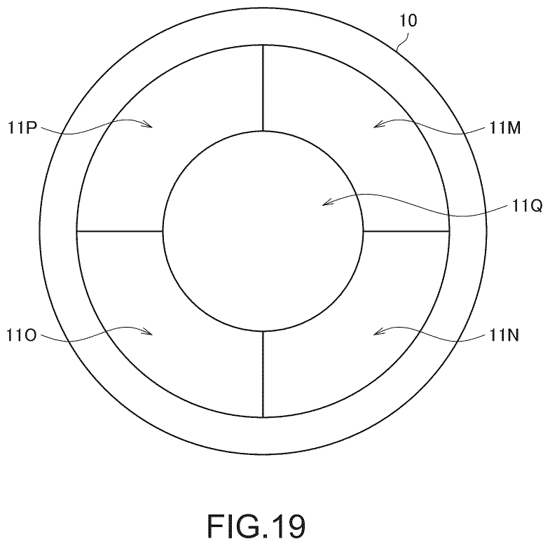

Here, the configuration of the haptic presentation apparatus 1 according to the third application example is not limited to the example shown in FIG. 16. FIGS. 18 and 19 are other examples of the upper layer 10 of the haptic presentation apparatus 1 according to the third application example. In the upper layer 10 shown in FIG. 18, upper layer containing spaces 11J to 11L are partitioned. In the upper layer 10 shown in FIG. 19, upper layer containing spaces 11M to 11Q are partitioned.

Moreover, FIG. 16 and FIGS. 18 and 19 show the examples in which the plurality of upper layer containing spaces 11 is present on the concentric circles, though not limited to these shapes. For example, the haptic presentation apparatus 1 according to the third application example may include the upper layer 10 in the shape as shown in FIG. 2.

### 6. Hardware Configuration Example

Hereinabove, the respective embodiments of the present disclosure have been described. Cooperation of software and hardware realizes the above-mentioned information processing. Hereinafter, a hardware configuration example that can be applied to the haptic presentation apparatus 1 will be described.

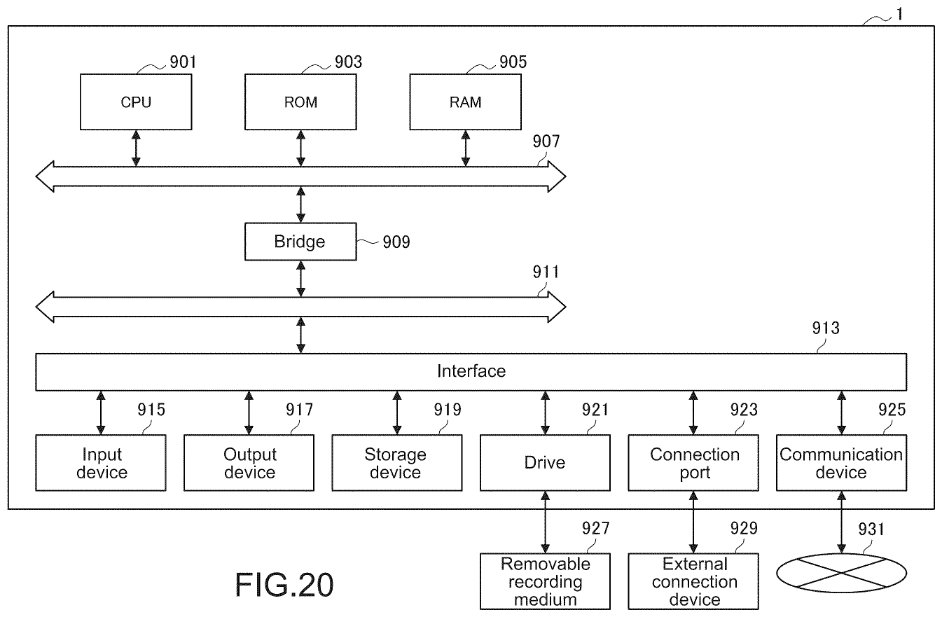

FIG. 20 is a block diagram showing an example of hardware configurations of the haptic presentation apparatus 1. It should be noted that the hardware configuration example of the haptic presentation apparatus 1 described below is merely an example of the hardware configurations of the haptic presentation apparatus 1. Therefore, the haptic presentation apparatus 1 does not necessarily need to include all the hardware configurations shown in FIG. 20. Moreover, some of the hardware configurations shown in FIG. 20 may be omitted from the haptic presentation apparatus 1.

As shown in FIG. 20, the haptic presentation apparatus 1 includes a CPU 901, a ROM 903, and a RAM 905. Moreover, the haptic presentation apparatus 1 may include a host bus 907, a bridge 909, an external bus 911, an interface 913, an input device 915, an output device 917, a storage device 919, a drive 921, a connection port 923, and a communication device 925. Instead of or in addition to the CPU 901, the haptic presentation apparatus 1 may include a processing circuit as called graphics processing unit (GPU), digital signal processor (DSP), or application specific integrated circuit (ASIC).

The CPU 901 functions as an arithmetic processing device and a control device and controls general operations in the haptic presentation apparatus 1 or some of them in accordance with various programs recorded on the ROM 903, the RAM 905, the storage device 919, or a removable recording medium 927. The ROM 903 stores programs, arithmetic operation parameters, and the like to be used by the CPU 901. The RAM 905 temporarily stores programs to be used for execution of the CPU 901 or/and parameters and the like, which are changed as appropriate, in the execution. The CPU 901, the ROM 903, and the RAM 905 are mutually connected through the host bus 907 constituted by an internal bus, such as a CPU bus. In addition, the host bus 907 is connected to the external bus 911, such as a peripheral component interconnect/interface (PCI) bus, via the bridge 909.

By the CPU 901 cooperating with the ROM 903, the RAM 905, and the software, the functions of the control unit 120 for example can be realized.

The input device 915 is an apparatus that is operated by, for example, buttons and the like. The input device 915 may include a mouse, a keyboard, a touch panel, a switch, a lever, and the like. Moreover, the input device 915 may include a microphone that detects the user's voice. The input device 915 may be a remote control device using, for example, infrared ray or other radio waves, or may be an external connection device 929, such as a portable phone, which is compatible with operations of the haptic presentation apparatus 1. The input device 915 includes an input control circuit that generates an input signal on the basis of information input by the user and outputs the input signal to the CPU 901. The user inputs various types of data to the haptic presentation apparatus 1 or instructs the haptic presentation apparatus 1 of processing operations by operating this input device 915.

Moreover, the input device 915 may include an image pickup device and sensors. The image pickup device is a device that picks up an image of a real space and generates the picked up image by using, for example, an image pickup element, such as a charge coupled device (CCD) or a complementary metal oxide semiconductor (CMOS), and various members, such as lenses for controlling formation of an image of a subject on the image pickup element. The image pickup device may be one that picks up a still image or may be one that picks up a moving image.

The sensor is various sensors, e.g., a distance measurement sensor, an acceleration sensor, a gyro sensor, a geomagnetic sensor, a vibration sensor, an optical sensor, and a sound sensor. The sensor acquires information about states of the haptic presentation apparatus 1, for example, an attitude and the like of a casing of the haptic presentation apparatus 1 or acquires information about the surrounding environment of the haptic presentation apparatus 1, such as brightness or noise around the haptic presentation apparatus 1. Moreover, the sensor may include a GPS sensor that receives a global positioning system (GPS) signal and measures latitude, longitude, and altitude of the apparatus.

The output device 917 is constituted by an apparatus capable of notifying the user of the acquired information visually or auditorily. The output device 917 can be, for example, a display device, such as a liquid crystal display (LCD) or an organic electro-luminescence (EL) display, a sound output device, such as a loudspeaker or headphones, and the like. Moreover, the output device 917 may include a plasma display panel (PDF), a projector, a hologram, a printer device, and the like. The output device 917 outputs a result obtained by the processing of the haptic presentation apparatus 1 as a text or a video, e.g., an image, or outputs a sound, such as a voice or audio effect. Moreover, the output device 917 may include a lighting device or the like that illuminates the periphery.

The storage device 919 is a device for storing data, which is configured as an example of the storage unit of the haptic presentation apparatus 1. The storage device 919 is constituted by a magnetic storage device, e.g., a hard disk drive (HDD), a semiconductor storage device, an optical storage device, or an optical magnetic storage device. The storage device 919 stores programs or various types of data to be executed by the CPU 901, various types of data externally acquired, and the like.

The drive 921 is a reader/writer for the removable recording medium 927, such as a magnetic disk, an optical disc, a magneto-optical disk, or a semiconductor memory, and is built in or externally mounted on the haptic presentation apparatus 1. The drive 921 reads out information recorded on the mounted removable recording medium 927 and outputs it to the RAM 905.

Moreover, the drive 921 writes a record on mounted removable recording medium 927.

The connection port 923 is a port for directly connecting the device to the haptic presentation apparatus 1. The connection port 923 can be, for example, a universal serial bus (USB) port, an IEEE1394 port, a small computer system interface (SCSI) port, or the like. Moreover, the connection port 923 may be an RS-232C port, an optical audio terminal, an HDMI (registered trademark) (High-Definition Multimedia Interface) port, or the like. The external connection device 929 is connected to the connection port 923, such that various types of data can be exchanged between the haptic presentation apparatus 1 and the external connection device 929.

The communication device 925 is, for example, a local network or a communication interface constituted by a communication device and the like for connecting to a communication network with a base station of wireless communication. The communication device 925 can be, for example, a wired or wireless LAN, Bluetooth, Wi-Fi, or a communication card for a wireless USB (WUSB), and the like. Moreover, the communication device 925 may be a router for optical communication, a router for an asymmetric digital subscriber line (ADSL), a modem for various types of communication, or the like. The communication device 925 sends and receives signals and the like, for example, to/from the Internet or another communication device using a predetermined protocol, such as TCP/IP. Moreover, a local network connected to the communication device 925 or a communication network with a base station is a network connected with a wire or wirelessly, and is, for example, the Internet, a home LAN, an infrared communication, a radio wave communication, a satellite communication, or the like.

### 7. Supplement

Although the favorable embodiments of the present disclosure have been described in detail with reference to the accompanying drawings, the technical range of the present disclosure is not limited to such examples. It is clear that a person having ordinary knowledge in the technical field of the present disclosure can conceive of various examples of changes or modifications within the scope of the technical ideas defined in the scope of claims, which are naturally understood to be within the technical scope of the present disclosure.

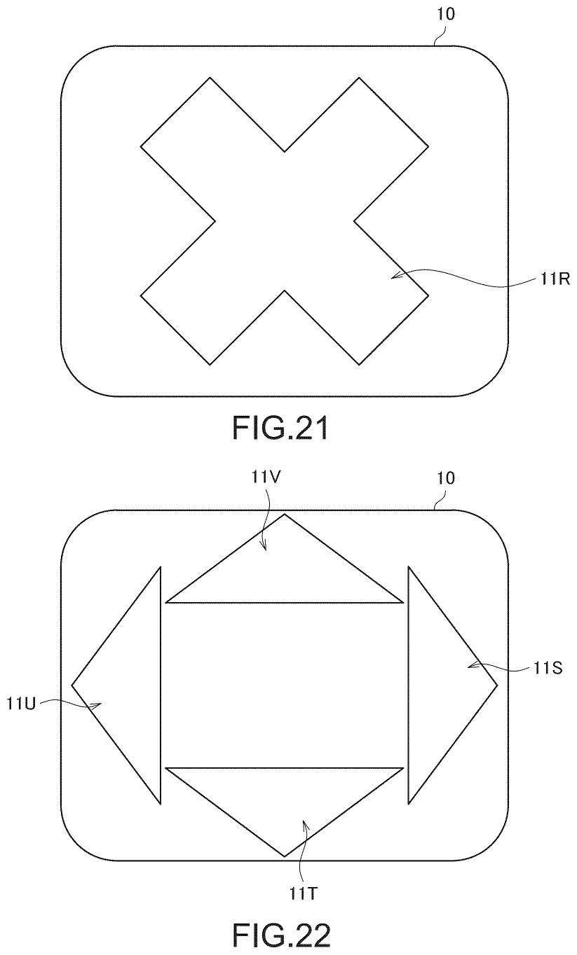

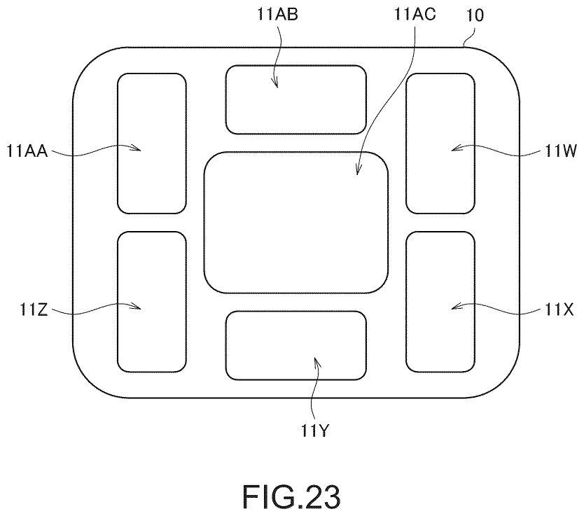

For example, the shapes of the upper layer containing spaces 11 and the lower layer containing space 21 are not limited to the above-mentioned shapes, and may be the shapes as shown in FIGS. 21 to 23, for example. FIGS. 21 to 23 are other examples of the upper layer 10 of the haptic presentation apparatus 1. In the upper layer 10 shown in FIG. 21, an upper layer containing space 11R is partitioned. In the upper layer 10 shown in FIG. 22, upper layer containing spaces 11S to 11V are partitioned. In the upper layer 10 shown in FIG. 23, upper layer containing spaces 11W to 11Z and upper layer containing spaces 11AA to 11AC are partitioned. It should be noted that a lower layer containing space 21 in a shape similar to those of the upper layer containing spaces 11 partitioned in the upper layer 10 shown so far may be partitioned in the lower layer 20.

Moreover, the example in which the haptic presentation apparatus 1 includes the two layers, the upper layer 10 and the lower layer 20, has been described so far. However, the haptic presentation apparatus 1 may include a plurality of lower layers 20 so that one lower layer 20 is stacked on another lower layer 20. In a case where the haptic presentation apparatus 1 includes a plurality of lower layers 20, the wall portions partitioning the lower layer containing space 21 partitioned in the lower layer 20 closer to the upper layer 10 are deformed by causing a fluid contained in another lower layer containing space 21 to flow in and out. Accordingly, the wall portion located between the upper layer containing spaces 11 and the lower layer containing space 21 is deformed, and the presentation surfaces 14 are deformed. Since the haptic presentation apparatus 1 includes the plurality of lower layers 20, a more complicated haptic sensation can be presented to the user.

Moreover, the example in which each of the plurality of containing spaces is partitioned in the upper layer 10 or the lower layer 20 has been described so far. However, a containing space partitioned over the upper layer 10 and the lower layer 20 may be present.

Moreover, the example in which a haptic sensation to the user is presented by the supply and discharge units 130 causing the fluid to flow into and out of the containing space has been described so far. However, the haptic presentation apparatus 1 may include another device, such as a Peltier device, in order to simultaneously present to the user sensations other than a haptic sensation, such as a warming sensation or a smell sensation.

Moreover, the effects described in the present specification are merely illustrative or exemplary, not limitative. That is, the technology according to the embodiment of the present disclosure can provide other effects obvious to those skilled in the art in light of the description of the present specification in addition to or instead of the above-mentioned effects.

It should be noted that the following configurations fall within the technical range of the present disclosure.
(1) An apparatus, including:
   a first containing space and a second containing space that contain a fluid, which are partitioned using an elastically deformable wall portion;
   a generation unit that generates a plurality of signals on the basis of a haptic feedback or a control signal for information notification to a user who uses the apparatus; and
   a supply and discharge unit that, on the basis of the signal generated by the generation unit, supplies the fluid to the first containing space and the second containing space and discharges the fluid from the first containing space and the second containing space, in which
   the first containing space is stacked on the second containing space so that the first containing space is located between the second containing space and the user in a state in which the apparatus is used by the user.
(2) The apparatus according to (1), in which
   the apparatus comprises the one first containing space or a plurality of the first containing spaces and the one second containing space or a plurality of the second containing spaces, and
   the one second containing space or the plurality of second containing spaces is partitioned in a layer that is stacked on a layer in which the one first containing space or the plurality of first containing spaces is partitioned.
(3) The apparatus according to (2), further including
   a control unit that determines, for each of the plurality of signals generated by the generation unit, a containing space to which and from which the fluid is supplied and discharged on the basis of the signal.
(4) The apparatus according to any one of (1) to (3), in which
   a signal for the supply and discharge unit to control the first containing space and a signal for the supply and discharge unit to control the second containing space are signals of different frequencies, the signals being generated by the generation unit.
(5) The apparatus according to (4), in which
   the generation unit generates, as the plurality of signals, a first signal including a frequency component of a frequency equal to or higher than a predetermined frequency in the control signal and a second signal including a frequency component of a frequency lower than a frequency of the first signal in the control signal.
(6) The apparatus according to any one of (1) to (5), in which
   the generation unit generates the plurality of signals by separating a control signal depending on whether strength of the control signal is positive or negative.
(7) The apparatus according to (3), in which
   the control unit determines, on the basis of an amplitude value of a signal generated by the generation unit, a containing space to which and from which the fluid is supplied and discharged on the basis of the signal.
(8) The apparatus according to (3), in which
   the plurality of signals generated by the generation unit is same in frequency and phase.
(9) The apparatus according to (8), in which
   the control unit determines the first containing space and the second containing space, which is stacked on the first containing space, as containing spaces to which and from which the fluid is supplied and discharged on the basis of each of the plurality of signals being same in the frequency and phase.
(10) The apparatus according to (3), in which
   the generation unit determines an amplitude value of each of the plurality of signals on the basis of the control signal, and
   the control unit determines each of a plurality of the first containing spaces adjacent to each other out of the plurality of first containing spaces on the basis of each of the plurality of signals, as the containing space to which and from which the fluid is supplied and discharged.
(11) The apparatus according to any one of (1) to (10), in which
   the generation unit determines an amplitude value of a signal to be generated on the basis of a threshold.
(12) The apparatus according to (3), further including
   a sensor unit that measures a distance between containing spaces or a pressure exerted on a containing space, in which the control unit controls, on the basis of a measurement result by the sensor unit, the supply and discharge of the fluid by the supply and discharge unit.
(13) The apparatus according to (2) or (3), in which
   the second containing space is stacked over the plurality of first containing spaces.
(14) The apparatus according to any one of (1) to (13), in which
   the apparatus comprises a plurality of at least either the first containing spaces or the second containing spaces, and
   the plurality of first containing spaces or the plurality of second containing spaces is present on concentric circles.
(15) The apparatus according to any one of (1) to (14), further including
   a plurality of layers in which the second containing space is partitioned.

### REFERENCE SIGNS LIST

1 haptic presentation apparatus
10 upper layer
11 upper layer containing space
12 outflow and inflow port
13 layer isolation portion
14 presentation surface
20 lower layer
21 lower layer containing space
110 communication unit
120 control unit
121 generation unit
130 supply and discharge unit
140 sensor unit
150 storage unit

What is claimed is:

1. An apparatus, comprising:
a first containing space and a second containing space that contain a fluid, which are partitioned using an elastically deformable wall portion;
a generation unit that generates a plurality of signals on a basis of a haptic feedback or a control signal for information notification to a user who uses the apparatus; and
a supply and discharge unit that, on a basis of the signal generated by the generation unit, supplies the fluid to the first containing space and the second containing space and discharges the fluid from the first containing space and the second containing space, wherein
the first containing space is stacked on the second containing space so that the first containing space is located between the second containing space and the user in a state in which the apparatus is used by the user.

2. The apparatus according to claim 1, wherein
the apparatus comprises the one first containing space or a plurality of the first containing spaces and the one second containing space or a plurality of the second containing spaces, and
the one second containing space or the plurality of second containing spaces is partitioned in a layer that is stacked on a layer in which the one first containing space or the plurality of first containing spaces is partitioned.

3. The apparatus according to claim 2, further comprising
a control unit that determines, for each of the plurality of signals generated by the generation unit, a containing space to which and from which the fluid is supplied and discharged on a basis of the signal.

4. The apparatus according to claim 1, wherein
a signal for the supply and discharge unit to control the first containing space and a signal for the supply and discharge unit to control the second containing space are signals of different frequencies, the signals being generated by the generation unit.

5. The apparatus according to claim 4, wherein
the generation unit generates, as the plurality of signals, a first signal including a frequency component of a frequency equal to or higher than a predetermined frequency in the control signal and a second signal including a frequency component of a frequency lower than a frequency of the first signal in the control signal.

6. The apparatus according to claim 1, wherein
the generation unit generates the plurality of signals by separating a control signal depending on whether strength of the control signal is positive or negative.

7. The apparatus according to claim 3, wherein
the control unit determines, on a basis of an amplitude value of a signal generated by the generation unit, a containing space to which and from which the fluid is supplied and discharged on a basis of the signal.

8. The apparatus according to claim 3, wherein
the plurality of signals generated by the generation unit is same in frequency and phase.

9. The apparatus according to claim 8, wherein
the control unit determines the first containing space and the second containing space, which is stacked on the first containing space, as containing spaces to which and from which the fluid is supplied and discharged on a basis of each of the plurality of signals being same in the frequency and phase.

10. The apparatus according to claim 3, wherein
the generation unit determines an amplitude value of each of the plurality of signals on a basis of the control signal, and
the control unit determines each of a plurality of the first containing spaces adjacent to each other out of the plurality of first containing spaces on a basis of each of the plurality of signals, as the containing space to which and from which the fluid is supplied and discharged.

11. The apparatus according to claim 1, wherein
the generation unit determines an amplitude value of a signal to be generated on a basis of a threshold.

12. The apparatus according to claim 3, further comprising
a sensor unit that measures a distance between containing spaces or a pressure exerted on a containing space, wherein
the control unit controls, on a basis of a measurement result by the sensor unit, the supply and discharge of the fluid by the supply and discharge unit.

13. The apparatus according to claim 2, wherein
the second containing space is stacked over the plurality of first containing spaces.

14. The apparatus according to claim 1, wherein
the apparatus comprises a plurality of at least either the first containing spaces or the second containing spaces, and
the plurality of first containing spaces or the plurality of second containing spaces is present on concentric circles.

15. The apparatus according to claim 1, further comprising
a plurality of layers in which the second containing space is partitioned.
